(19) United States
(12) Patent Application Publication
(10) Pub. No.: US 2018/0124150 A1
(43) Pub. Date: May 3, 2018

(54) REMOTE ACCESS OF CELLULAR COMMUNICATION DEVICES FOR SOFTWARE DEVELOPMENT AND TESTING

(71) Applicant: T-Mobile USA, Inc., Bellevue, WA (US)

(72) Inventors: Peter P. Myron, Renton, WA (US); Michael J. Mitchell, North Bend, WA (US)

(21) Appl. No.: 15/338,069

(22) Filed: Oct. 28, 2016

(51) Int. Cl. H04L 29/08; H04L 29/06; H04L 29/12; H04W 4/00; H04W 24/06

(52) U.S. Cl. CPC H04L 67/025; H04L 69/16; H04W 84/04; H04W 4/003; H04W 24/06; H04L 61/2007

(57) ABSTRACT

A provider of a cellular communication network may maintain a cluster of test devices that are remotely accessible for software testing. Access to a test device may be by way of an Internet server and by way of an interface device that is connected to the test device by USB. The Internet server exposes a TCP port to which a development device may connect. The TCP port is logically connected, through the server computer and the interface device, to a logical control and diagnostic interface of the test device. As an example in the Android environment, the TCP port is logically connected through the server computer and through the interface device to an ADB (Android device bridge) interface of the test device. The server computer may be configured to provide access control and to selectively grant access to the test devices.

### BACKGROUND

A provider of a cellular communication network typically sells communication devices that are selected and/or optimized for use with the services of the provider. The provider may at times work with software developers so that various types of software can be optimized for use on the devices that are available from the provider. This typically requires the developers to be in possession of the devices upon which the software is to be run.

Often, however, the developers may be at various world-wide locations, and it may be difficult or inconvenient for the developers to obtain the different types of devices that are or have been available on the provider's network. This may be particularly true for “legacy” devices that may be in use on the provider's network but which are no longer sold. This may also be particularly true for new devices that have not yet been released to consumers.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of a testing environment that includes multiple test devices that are accessible through the Internet by one or more development devices.

FIG. 2 is a block diagram showing further details of the testing environment shown in FIG. 1.

FIG. 3 shows an example of a user interface that may be presented to show characteristics of test devices and to allow selection of a particular test device by a software developer.

FIG. 4 shows an example of a user interface that may be presented to allow control by a developer of a selected test device.

FIG. 5 is a flow diagram illustrating an example method of providing access to test devices for software development and testing.

FIG. 6 is a block diagram illustrating example high-level components of a test device in the environment of FIG. 1.

FIG. 7 is a block diagram illustrating example high-level components of a computing device that may be used as a server computer in the environment of FIG. 1.

FIG. 8 is a block diagram illustrating example high-level components of an interface device such as may be used in the environment of FIG. 1.

### DETAILED DESCRIPTION

The described implementations provide devices, systems, and methods that allow developers and testers to access remotely located banks or clusters of test devices. In accordance with techniques that are described in more detail below, a provider of a cellular communication network maintains a cluster of multiple test devices at a location that is convenient for the provider. The test devices may include examples of the various types of cellular communication devices that have been sold, are currently being sold, and/or that are in development prior to being sold by the provider.

Communications with the test devices, such as communications by remotely located developers, are facilitated by multiple interface devices and one or more server computers. Each interface device comprises a relatively small and inexpensive single-board computer having multiple USB (universal serial bus) ports. Each interface device is connected to corresponding test devices. The connection between an interface device and a corresponding test device is through a USB cable extending between one of the USB ports of the interface device and a corresponding USB port of the test device. Each interface device also has a network communications interface, such as an Ethernet interface, which is connected to a wide-area network such as the Internet.

The test devices have logical control interfaces that may be accessed through the USB ports of the devices, for interacting with and controlling the test devices.

A server computer is configured to communicate through the wide-area network and through the interface devices with the logical control interfaces of the test devices. Specifically, a first communication channel is established between the server computer and an interface device, through the network interface of the interface device. A second communication channel is established between the interface device and the test device, through the USB connection between the interface device and the test device. The interface device is configured to relay communications between the first and second communication channels.

Because communications between the server computer and the interface devices are over a wide-area network, the server computer can be located at a different geographic location than the interface devices and the test devices.

In certain implementations, the server computer implements a communication port corresponding to each test device, wherein each communication port is logically connected to the logical control interface of a corresponding test device through the first and second communication channels described above. Each communication port is accessible through a wide-area network such as the Internet, allowing a developer at any world-wide location to access any of the test devices for software development and testing.

In order to add a new test device for access through the server computer, the test device is connected by USB to a corresponding interface device, which itself has been configured by installing a memory card having an appropriate code image. Little or no configuration of the test device itself is required. The use of multiple interface devices, with each interface device supporting a small number of test devices, makes it relatively easy to add new test devices to an existing cluster of test devices. Further advantages of using multiple interface devices include redundancy, mobility, and easy replicability. In addition, the use of multiple interface devices reduces communication latencies by allowing separate channels for smaller groups of devices. Multiple interface devices also allow simpler scheduling and resource allocation.

The server computer may implement an Internet-accessible user interface (UI) through which developers may obtain access to individual test devices. The UI may, for example, display a list of available test devices and their characteristics. Upon request, the UI may provide a port specification for a particular test device. Upon obtaining the port information, a developer can configure a diagnostic client for connection to the particular test device through the communication port of the server computer.

The UI created by the server computer may also allow a developer to interact with and/or control a particular test device in other ways. For example, the UI may display a live copy of the display screen of the test device. As another example, the UI may implement a control for accessing a file system of a test device. As another example, the UI may provide facilities for allowing a developer to manage applications that are installed on the test devices, including installing and running applications.

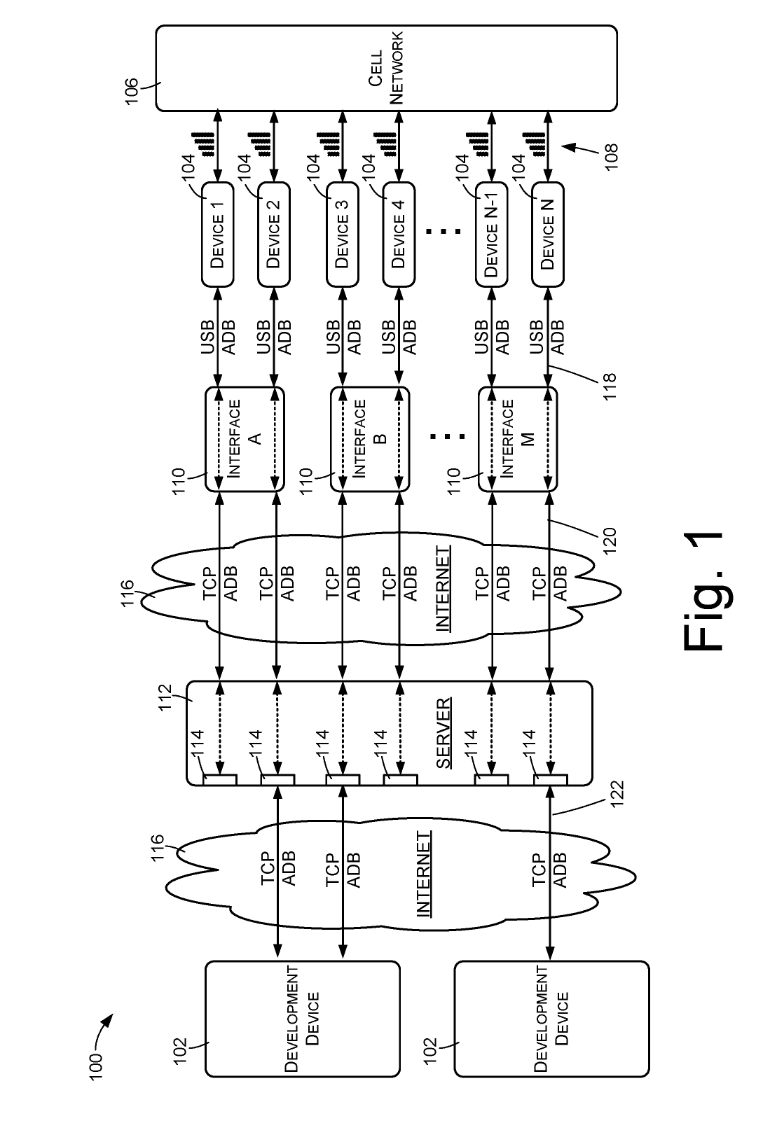

FIG. 1 illustrates a testing environment 100 for cellular communication devices such as smartphones, tablet computers, wearable devices, and other mobile devices. The testing environment 100 allows one or more development platforms or devices 102 to communicate with one or more remotely located test devices 104 and to perform testing and development on the test devices 104 as if the test devices 104 were co-located with the development devices 102.

As an example, a cellular communications network provider may maintain a bank or cluster of the test devices 104, which may be located at a facility of a cellular communications network provider. The test devices 104 may comprise devices that have been or will be provided for use on a cellular communication network 106 of the provider. Such test devices may include devices that are currently available to consumers, devices that are in development for future release to consumers, and “legacy” devices that are no longer manufactured, produced, or sold, but which may still be in use by consumers.

The development devices 102 may include computers and computer-based devices that are used to develop and test software for the test devices 104. For example, a development device 102 may comprise a desktop computer or other similar computer upon which has been installed software that facilitates writing and deploying code for the test devices 104. The development devices 102 may be at locations or facilities other than those of the cellular communications provider, such as the facilities of the developers or testers of device software. For example, the test devices 104 may be at a location in North America while the development devices 102 may be in other world locations such as India, Europe, etc.

The test devices 104 are provisioned to operate as part of the cellular communication network 106. In practice, the testing environment 100 may be implemented by a cellular communications provider for use by developers of software that will be used on communication devices sold by the provider, and the cellular network 106 may be a communication network implemented and provided by the same cellular communications provider. The test devices 104 may have SIMs (subscriber identity modules) that have been registered with the cellular communications provider for use on the cellular network 106. Accordingly, the test devices 104 may be configured to communicate using wireless cellular communication signals 108 with and over the cellular communication network 106. The cellular communication network 106 may in turn provide communications through wide-area networks such as the Internet.

The cellular communication network 106 also supports traditional cellular services such as voice calls, text messaging, and other functionality such as various IMS (IP multimedia subsystem) services. In certain implementations, the cellular communication network 106 may comprise a GSM (global system for mobile communications) network and may accordingly use various protocols and standards encompassed by the GSM standard.

In the described embodiment, each of the test devices 104 operates using any one of several variants of the Android operating system, including variants intended for phones, tablets, wearable devices, laptop computers, etc., and including variants intended for devices of different manufacturers.

The development devices 102 may be configured for Android software development, such as by running an instance of an IDE (integrated development environment) designed for Android software development and testing. Android Studio is an example of such an IDE that is available for the Android platform.

The Android platform and operating system support a debugging and development tool called Android debug bridge or ADB. ADB includes a communication stack that facilitates communications between a development device 102 (referred to as a client device) and a test device 104. Such communications may comprise TCP (transmission control protocol) communications. In addition, the ADB communications stack includes provisions for communicating using TCP over USB (universal serial bus). Android devices typically have USB communication ports and are configured to expose ADB functionality through their USB communication ports.

In addition to defining transport-level mechanisms for communicating between a client and a test device, ADB defines a logical control interface (referred to herein as an ADB interface) that includes a command/query language and syntax for interacting with Android-based devices, allowing the client devices to control the devices for development and testing.

Note that although the testing environment 100 is described in the context of the Android operating system and associated development tools, the described techniques can also be used in conjunction with devices that use other operating systems and development platforms. Various types of devices support remote debugging functionality and logical control interfaces, and can be connected in ways similar to those described herein.

FIG. 1 shows a group of test devices 1 through N, which may be collectively considered as and referred to as a test device cluster. The cellular communications provider may maintain and provide multiple test clusters for various purposes and/or for various types or groups of developers and testers. Each test device 104 of the cluster has a wired communication port such as a USB (universal serial bus) port. In addition, each test device 104 implements a logical control interface that can be accessed through the USB port for interacting with and controlling the test device. In certain embodiments, the logical control interface may comprise an ADB (Android debug bridge) interface. In other embodiments, logical control interfaces may support remote debugging using different protocols.

Various mechanisms are implemented in the environment 100 to allow a development device 102 to communicate using ADB with a remotely located test device 104. In addition, a web interface is provided so that a developer may select and interact with available test devices 104. The web interface may provide access control and device brokering so that only authorized developers are able to use the test devices 104 and so that only one developer at a time is allowed to communicate with any particular test device 104.

At the location where the devices 104 are located, each test device 104 is connected by a wired USB connection to an interface device 110. Each interface device 110 may comprise a relatively inexpensive diskless, single-board computer or controller having an Ethernet network port and one or more other wired communication ports such as USB (universal serial bus) device ports. Each interface device 110 may be configured and programmed by way of a code image that is stored on a removable memory card. For example, the interface device 110 may have a slot into which a removable SD memory card is inserted, and the code image for the interface device 110 may be stored on the SD memory card. The interface device 110 may be easily reconfigured by changing its memory card.

In the example shown by FIG. 1, each interface device 110 is connected to a corresponding test device 104 through the wired communication port of the test device 104. Specifically, each interface device 110 is connected by USB cables to the USB communication ports of two test devices 104, using respective USB communication ports of the interface device 110.

In addition to the components described so far, the environment 100 includes a server 112 that can be accessed by developers and by the development devices 102 for interacting with the test devices 104. The server provides a logical communication port or endpoint corresponding to each of the test devices 104. In the described embodiment, each endpoint comprises a TCP network communication port 114 and an associated ADB interface that can be accessed using the TCP communications mode of the ADB protocol. A TCP port such as this is defined by an IP (Internet protocol) address of the server 112 and a TCP port number, where the port number is unique for every test device 104 that is accessed through a particular server 112.

In combination, the server 112 and the interface devices 110 are configured to create a communication channel corresponding to each test device 104. The communication channel for a particular test device 104 extends between the USB port of the test device 104 and the corresponding network communication port 114 of the server 112.

Communications between a development device 102 and a port 114 of the server 112 may be through a public communications network such as the Internet 116. Because the Internet has world-wide coverage, the development device 102 and the server 112 may be located at different geographic locations around the world.

The server 112 communicates with each interface device 110 through a public communications network or other wide-area network, which may again comprise the Internet 116. Communications between the server 112 and the interface devices 110 are used to create connections with the interface devices 110, corresponding to the respective test devices 104. In the described embodiment, the connections may comprise TCP-based ADB connections.

The server 112 and the interface devices 110 are configured in combination to extend communications from the development device 102, through the ports 114, and to the respective and corresponding test devices 104. In the described embodiment, the wired connection between the USB ports of a device 104 and an interface device 110 forms a TCP-over-USB ADB communication channel 118. Specifically, a corresponding first TCP-based ADB communication channel 120 is established between the server 112 and the interface device 110 over the Internet 116. A development device 102 then establishes a second TCP-based ADB communication channel between the development device 102 and the port 114 of the server 112 that corresponds to the device 104.

The server 112 is configured to relay control communications between the port 114 and a TCP port (not shown) of the corresponding interface device 110. Similarly, the interface device 110 is configured to relay control communications between the server 112 and the device 104. In certain embodiments, communication channels between the server 112 and the interface devices are established using corresponding TCP ports on the server 112 and the interface devices 110.

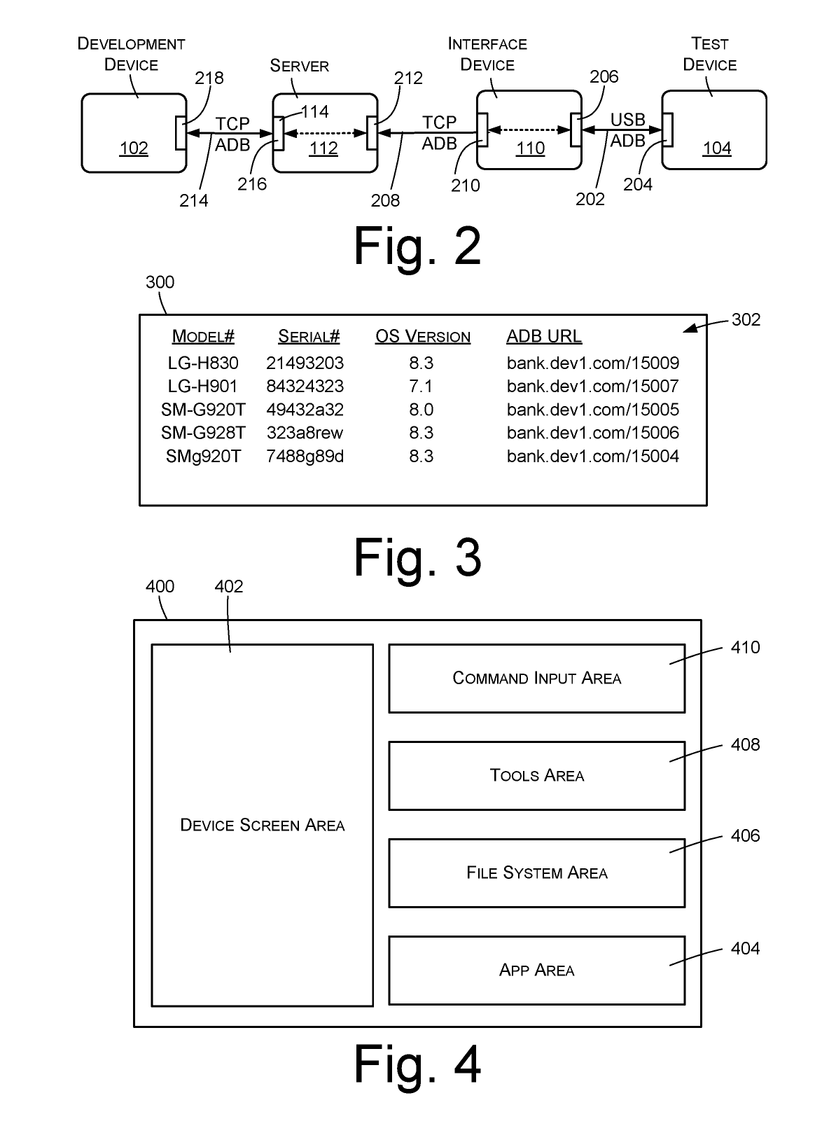

FIG. 2 illustrates further details regarding communication mechanisms that are used between a single development device 102 and a single test device 104. In the described embodiment, a communication channel, such as a TCP communication channel, is created for each test device 104. The communication channel is then used for control communications, such as ADB communications. The communication channel extends between the development device 102 and the test device 104.

The communication channel comprises multiple TCP channel segments, which are used to communicate ADB commands, queries, and responses. A first TCP channel segment 202 is implemented over a wired USB connection between respective interfaces 204 and 206 of the test device 104 and the interface device 110. A second TCP channel segment 208 is implemented over a network connection between respective interfaces 210 and 212 of the interface device 110 and the server 112. A third TCP channel segment 214 is implemented over a network connection between respective interfaces 216 and 218 of the server 112 and the development device 102.

Each of the interfaces 204, 206, 210, 212, 216, and 218 comprises both a physical interface and one or more logical interfaces. Specifically, each of the interfaces 204 and 206 comprises a physical USB interface as well as logical TCP and ADB interfaces. Each of the interfaces 210, 212, 216, and 218 comprises a physical Ethernet interface as well as logical TCP and ADB interfaces.

FIG. 3 illustrates a simplified example of a web-based user interface (UI) 300 that may be provided by the server 112, and which may be accessed by a developer through the Internet regardless of the location of the developer. The illustrated UI 300 is an example of many different configurations and types of interfaces that may be implemented by or in conjunction with the server 112.

In the illustrated example, the UI 300 is configured to list the test devices 104 of a cluster. More specifically, the UI 300 presents a listing of available test devices 104, where the listing shows the characteristics of each test device such as manufacturer, model, model release date, size of installed memory, serial number, operating system version, physical location of the device, the cellular communication provider for which the device has been provisioned, and so forth.

More specifically, in the example of FIG. 3, the UI 300 contains a table 302 in which each row corresponds to a respective test device that is currently available for access by the developer. The table 302 has multiple columns, where each column specifies a characteristic of an available test device 104. In this example, the columns correspond to the device model number, the device serial number, and the operating system version of the device. The table 302 also has a column showing a port specification corresponding to the test device. The port specification includes a port number of the server-provided communication port corresponding to the test device. In some cases, the port specification may be part of a URL through which the logical control interface of the test device may be accessed. In some cases, the URL or port specification may be revealed to a requesting developer only after the test device has been allocated or assigned to that user. The table 302 in some cases may also have a state or status column (not shown), indicating whether the device is currently in use and/or indicating various state information about the device.

A developer may access the web-based UI 300 to view available test devices and to select a particular test device. Furthermore, the developer may note the URL and/or port specification associated with the selected test device, and may use the URL and/or port specification to configure a development device 102 to communicate through the appropriate server port 114 with the selected test device 104.

In many cases, software development and testing platforms such as used on the development devices 102 may have provisions for communicating with different test devices using TCP-based ADB communications or other types of communications that may be supported by other mobile operating systems. In order to configure a development and testing platform such as this to communicate with a particular test device, a user of the development platform is asked to specify an IP address and network port that correspond to the test device. In the illustrated embodiment, the user of the development platform can copy the URL provided by the web-based UI 300 and paste the URL into an appropriate field of the development platform UI. After doing this, the development platform is able to communicate with the ADB interface of the device 104 that has been selected by the user, through the port 114 specified by the URL, and any of the various development and debugging capabilities of the development environment may be used in conjunction with the test device 104.

The server 112 may implement access controls, so that only authorized users are allowed to access the user interface 200. Access controls may also be implemented to restrict certain users to the use of certain test devices. Upon receiving a request from a user for access to a particular test device, the server 112 may record an allocation and/or assignment of the device to the requesting user and may provide a URL to the user through which the assigned device may be accessed. During times when a device is assigned, other users may be prevented from accessing the test device. For example, a first test device may be assigned to a first entity during a period of time, and the server may prevent access to the first test device by a second entity (or any other entity) during the period of time that the first test device is assigned to the first entity.

The server 112 may be configured to reinitialize or “factory reset” test devices after they have been released by users, so that the devices are ready for use by other users. Alternatively, the server 112 may maintain state information for each test device 104 so that configuration changes made by one user may be rolled back before assigning the test device to another user. The server 112 may communicate with the test devices through the interface devices 110, using the TCP-based ADB connections between the server 112 and the interface devices 110, in order to configure the test devices 104 in this manner

FIG. 4 shows another example of a web-based UI 400 that may be provided by the server 112 to provide additional functionality for accessing individual test devices 104, without necessarily involving the use of a development device 102. For example, the UI 400 may allow a user to interact with and control a selected test device 104. Specifically, the UI 400 may include a screen area 402 in which is displayed a live version of the screen of the test device 104. The screen area 403 may also allow the user to interact with the device by providing screen selection and other inputs to the device.

The UI 400 may include an application area 404 that may be accessed by a user to upload and install an application on the test device 104, as well as to view an manage other applications that are installed on the test device. The screen area 402 and the application area 404 may be used to run an application, to observe the output display of the application, and to interact with the application by providing navigational inputs.

As another example, the web-based UI 400 may provide a file system area 406 having functionality of a file system browser, allowing the user to view and interact with the file system of the test device 104.

The web-based UI 400 may also have a command input area that implements a command line interface or shell, allowing the user to interact with the test device using ADB commands and queries.

Generally, the web-based UI 400 may contain any of various components and functionality that may be useful to developers and testers of the test devices 104. In some implementations, the UI 400 may display ADB port information corresponding to the test device 104, such as a port specification for one of the ports 114 corresponding to the test device 104.

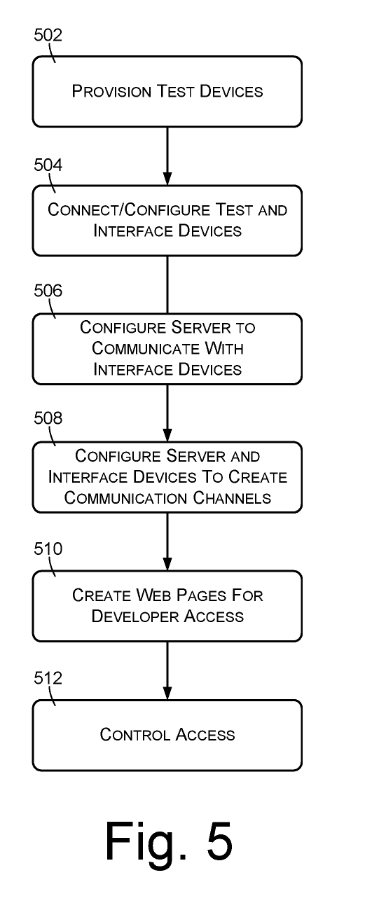

FIG. 5 illustrates an example method 500 for providing remote access for software development and testing of test devices. The example method 500 may be performed in the environment described above with respect to FIG. 1, although the method 500 may also be performed in ways and in environments other than those explicitly shown.

An action 502 comprises provisioning multiple test devices for communicating as part of a cellular communications network, such as a communications network designed to support various types of wireless, mobile communication devices. The test devices may comprise devices of the types and makes that might be used in conjunction with the cellular communications network, such as devices that are, have been, or will be sold by the provider of the communications network. In some cases, the test devices may be devices that are being developed for future release and sale.

The devices may have physical communication ports, and may provide logical control interfaces at the communication ports. For example, a particular device may have a physical USB communication port and may also expose a logical control interface via the USB communication port. In certain environments, the logical control interface may comprise an ADB interface.

An action 504 comprises connecting and configuring multiple interface devices for communicating with the test devices. More specifically, the action 504 comprises providing a local, wired, USB connection between each test device and one of multiple interface devices, and configuring the interface devices to communicate with the test devices through the logical control interfaces of the test devices. In the Android environment, the interface devices act as ADB clients with respect to the test devices.

The test devices and the interface devices may be co-located within a testing facility or any other facility, such as on the premises of the cellular network provider. The interface devices may comprise relatively simple and inexpensive computers that can be programmed and configured by way of code images that are stored in removable memory cards. The interface devices can be reconfigured by replacing their memory cards with cards having different code images.

An action 506 comprises configuring a server to communicate with the interface devices. The server may be geographically located at a different location than the interface devices and may communicate with the interface devices over a wide-area network such as the Internet. In some embodiments, communications may use TCP-based ADB communication channels that correspond respectively to the test devices. Note that the terms “server” and “server computer” are used herein to indicate a physical computer, a virtual server or computer, a single device, a collection of devices or servers, or any other virtual or physical components that provide similar functionality.

An action 508 comprises configuring the server and interface devices to create and provide communication channels between the server and the test devices. The action 508 includes creating and exposing network communication ports at the server corresponding respectively to each of the test devices. The network communication channels are accessible by users and software development devices through the network communication ports to communicate with the ADB control interfaces of the test devices.

In the described embodiment, each network communication port comprises a TCP port. Each TCP port is defined at least in part by the IP address of the server and by a TCP port number assigned by the server. Each communication channel corresponds to a particular test device and extends between one of the network communication ports and the corresponding test device. Each communication channel comprises a network communication channel between one of the network ports and one of the interface devices and a USB communication channel between said one of the interface devices and the logical ADB control interface of the corresponding test device. Accordingly, each communication channel is implemented in part by one of the interface devices, which relays communications between the server and the test device.

An action 510 comprises creating one or more web pages that are accessible to users such as software developers and testers. Certain web pages may be configured to display information about available test devices, for example. In some cases, one or more web pages may be made available for displaying port information and/or other connection information for respective test devices. By viewing pages such as this, developers can note connection information and connect from their own devices over a wide-area network such as the Internet, regardless of relative locations of the developers and test devices.

Web pages may also be used for displaying real-time information such as diagnostic information, audio and video generated by the test devices, other output generated by the test devices, etc. Web pages may further be used for inputting information and allowing developers to control test devices, such as by installing and running application or interacting with a diagnostic or debugging interface of a device using a text-based command line.

An action 512 comprises controlling access to both the web pages and to the network communication ports exposed by the server. The action 512 may comprise authorizing users prior to allowing the users to view web pages. The action 512 may also comprise restricting access by users so that certain users are only allowed access to certain devices. Furthermore, the action 512 may include controlling access to individual devices so that no more than one developer is allowed to access a device at any one time.

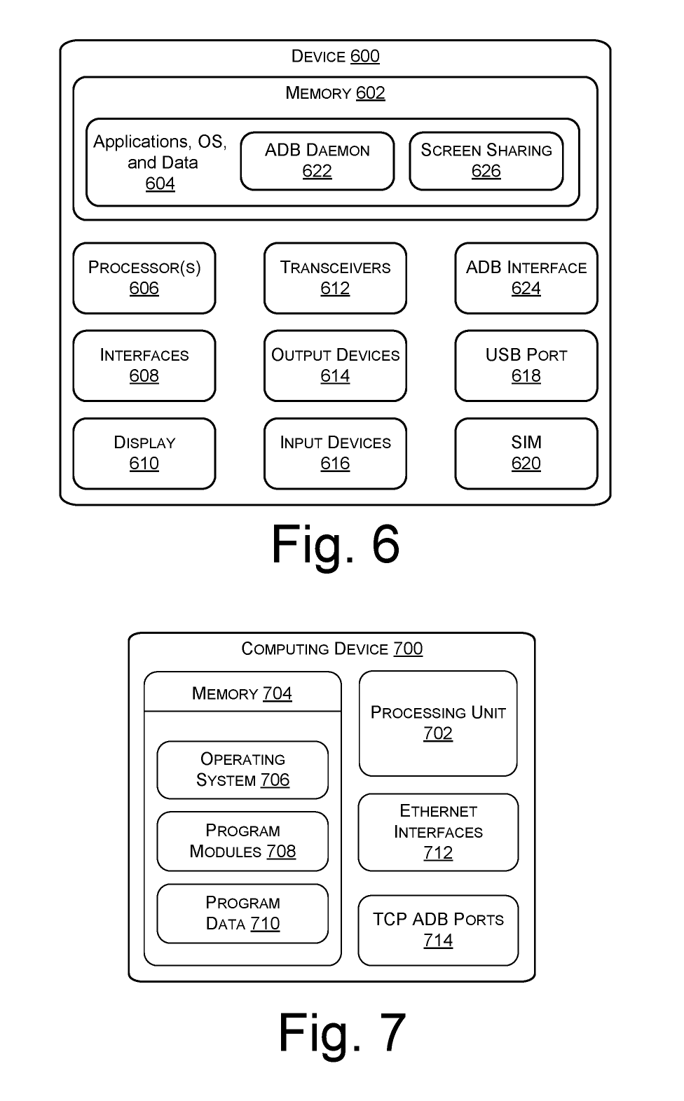

FIG. 6 illustrates an example communication device 600 in accordance with various embodiments. The device 600 is illustrative of a test device 104.

The device 600 may include memory 602, which may store applications, an operating system (OS), and data 604. The device 600 further includes processor(s) 606, interfaces 608, a display 610, radio transceivers 612, output devices 614, and input devices 616.

In various embodiments, the memory 602 comprises one or more machine-readable media, which may in turn include volatile and/or non-volatile memory. The memory 602 can also be described as non-transitory computer storage media and may include removable and non-removable media implemented in any method or technology for storage of information, such as computer readable instructions, data structures, program modules, or other data.

Non-transitory computer-readable media may include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the device 600.

In some embodiments, the processor(s) 606 is a central processing unit (CPU), a graphics processing unit (GPU), or both CPU and GPU, or other processing unit or component known in the art.

In various embodiments, the interfaces 608 are any sort of interfaces known in the art. The interfaces 608 may include any one or more of an Ethernet interface, wireless local-area network (WLAN) interface, a near field interface, a DECT chipset, or an interface for an RJ-11 or RJ-45 port. A wireless LAN interface can include a Wi-Fi interface or a Wi-Max interface, or a Bluetooth interface that performs the function of transmitting and receiving wireless communications using, for example, the IEEE 802.11, 802.16 and/or 802.20 standards. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFID enabled.

In various embodiments, the display 610 may comprise a liquid crystal display or any other type of display commonly used in telecommunication devices or other portable devices. For example, the display 610 may be a touch-sensitive display screen, which may also act as an input device or keypad, such as for providing a soft-key keyboard, navigation buttons, or the like.

In some embodiments, the transceivers 612 include any sort of transceivers known in the art. For example, the transceivers 612 may include radio, radios, and/or radio transceivers and interfaces that perform the function of transmitting and receiving radio frequency communications via an antenna, through a cellular communication network of a wireless data provider. The radio interfaces facilitate wireless connectivity between the device 600 and various cell towers, base stations and/or access points.

In some embodiments, the output devices 614 include any sort of output devices known in the art, such as a display (already described as display 610), speakers, a vibrating mechanism, or a tactile feedback mechanism. The output devices 614 also include ports for one or more peripheral devices, such as headphones, peripheral speakers, or a peripheral display.

In various embodiments, the input devices 616 include any sort of input devices known in the art. For example, the input devices 616 may include a microphone, a keyboard/keypad, or a touch-sensitive display (such as the touch-sensitive display screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

The device 600 may have a USB (universal serial bus) port 618 that provides communications with clients and peripheral devices. The USB port 618 may also in some cases serve as a battery charging port.

The device 600 may have a SIM (subscriber identity module) 620, which is a removable smart card used to identify a user of the device 600 to a service provider network.

In some embodiments, the Applications, OS, and data 604 may include an ADB daemon 622, which is an application that runs as a background process to respond to ADB commands. The ADB daemon 622 creates and communicates through an ADB interface 624, which is accessible through the USB port 618.

The Applications, OS, and data 604 may also include a screen sharing application 626, which is another application that runs as a background process to allow an external device to emulate the screen output and touch-screen input of the device 602. The server 112 may have a corresponding application that is capable of displaying the content of the screen of the device 104 on a web interface, of detecting user input at the web interface, and providing the user input back to the device 104.

FIG. 7 is a block diagram of an illustrative computing device 700 such as may be used to implement the server 112. In various embodiments, the computing device 700 may include at least one processing unit 702 and memory 704. Depending on the exact configuration and type of computing device, the system memory 704 may be volatile (such as RAM), non-volatile (such as ROM, flash memory, etc.) or some combination of the two. The memory 704 may include an operating system 706, one or more program modules 708, and may include program data 710. The memory may also include data storage devices (removable and/or non-removable) such as, for example, magnetic disks, optical disks, or tape.

The memory 704 may comprise non-transitory computer storage media. Such non-transitory computer storage media may include volatile and nonvolatile, removable and non-removable media implemented in any method or technology for storage of information, such as computer readable instructions, data structures, program modules, or other data. The non-transitory computer-readable storage media may further include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700.

In various embodiment, any or all of the memory 704 may store programming instructions which, when executed, implement some or all of the function functionality described above as being implemented by the server 112.

The computing device 700 may have one or more Ethernet interfaces 712, which may be used for connecting to a wide-area network such as the internet. As described above, the computing device 700 may create and expose multiple TCP-based ADB ports 714 for communications with external devices such as the development devices 102 and the interface devices 110.

The computing device 700 may have various other elements such as a keyboard, a mouse, a touch-sensitive display, voice input device, etc. Output device(s) such as a display, speakers, a printer, etc. may also be included.

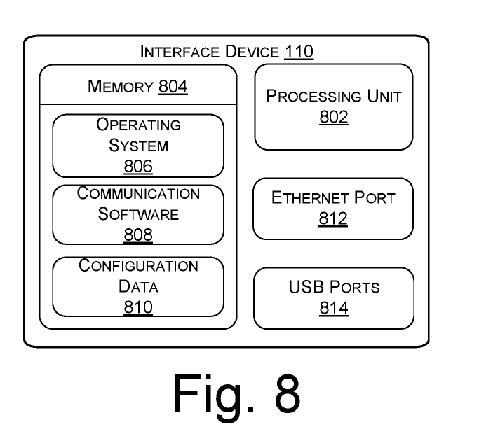

FIG. 8 illustrates an example implementation of an interface device 110, and shows basic, high-level components of such as device. The components may include at least one processing unit 802 and associated memory 804. In the described embodiment, the memory includes a removable, non-volatile memory card such as may be implemented using flash memory technologies. Such a removable memory card may be used to store a code image in order to configure operation of the interface device 110.

Generally, the memory 804 comprises non-transitory computer storage media of various types. Such non-transitory computer storage media may include volatile and nonvolatile, removable and non-removable media implemented in any method or technology for storage of information, such as computer readable instructions, data structures, program modules, or other data. The non-transitory computer-readable storage media may further include, but is not limited to, RAM, ROM, EEPROM, flash memory or other memory technology.

In various embodiment, any or all of the memory 804 may store programming instructions which, when executed by the processing unit 802, implement some or all of the function functionality described above as being implemented by the interface device 110.

More specifically, the memory 804 may include an operating system 806 and various other software. As a specific example, FIG. 8 shows communication software 808 such as may be used to communicate with the server 112 and the test devices 104. The memory 804 may also contain various types of configuration data 810.

The interface device 110 may have an Ethernet interface 812 for communications with the server 112 over a wide-area network such as the Internet. The interface device 110 may have multiple USB ports 814 for communication with the test devices 104.

Although features and/or methodological acts are described above, it is to be understood that the appended claims are not necessarily limited to those features or acts. Rather, the features and acts described above are disclosed as example forms of implementing the claims.

What is claimed is:

1. A system comprising:
multiple mobile devices located at a first location, each mobile device being provisioned to operate as part of a cellular communications network, each mobile device having a USB (universal serial bus) communication port, each mobile device having a logical control interface that is accessible through the USB communication port of the mobile device;
multiple interface devices at the first location, each interface device being connected to a corresponding mobile device through the USB communication port of the corresponding mobile device;
a server computer at a second location other than the first location, the server computer being configured to provide TCP (transport control protocol) communication ports corresponding respectively to the mobile devices;
the server computer and the interface devices being configured to create communication channel corresponding to each mobile device, the communication channel for a particular mobile device extending between the logical control interface of the particular mobile device and the TCP communication port corresponding to the particular mobile device; and
the TCP communication ports being accessible through the Internet for use by software developers and testers.

2. The system of claim 1, wherein:
each TCP communication port is defined by an IP (Internet protocol) address of the server computer and a TCP port number; and
the communication channel corresponding to the particular mobile device comprises a TCP-based communication channel between the server computer and the interface device corresponding to the particular mobile device.

3. The system of claim 1, wherein communications between the server computer communicates and the interface devices are over the Internet.

4. The system of claim 1, wherein the interface devices comprise diskless single-board computers having removable memory cards, each interface device being configured by storing a code image on the memory card of the interface device.

5. The system of claim 1, wherein each interface device is connected to no more than two of the mobile devices.

6. The system of claim 1, wherein the mobile devices comprise one or more of:
devices that are currently available to consumers;
devices that are in development for future release to consumers; and
devices that were previously available to consumers but that are no longer available to consumers.

7. The system of claim 1, wherein:
the server computer is configured to provide a user interface (UI) that is accessible as one or more web pages through the Internet, the UI identifying one or more characteristics of the mobile devices;
the UI allowing selection of an individual mobile device for access through the TCP communication port corresponding to the individual mobile device; and
the server computer being further configured to provide a port specification corresponding to the individual mobile device in response to selection of the individual mobile device, the port specification indicating at least a port number of the TCP communication port corresponding to the individual mobile device.

8. The system of claim 1, wherein the server computer is configured to assign a first mobile device to a first entity and to prevent access to the first mobile device by a second entity while the particular mobile device is assigned to the first entity.

9. A system comprising:
multiple cellular communication devices, each cellular communication device being provisioned to operate as part of a cellular communications network, each cellular communication device having a wired communication port, each cellular communication device being configured to implement a logical control interface through the wired communication port of the cellular communication device;
multiple interface devices, each interface device having a wired communication port that is connected to a corresponding cellular communication device through the wired communication port of the corresponding cellular communication device;
a server computer configured to provide network communication ports corresponding respectively to the cellular communication devices;
the server computer and the interface devices being configured to create a communication channel corresponding to each cellular communication device, the communication channel for a particular cellular communication device extending between the wired communication port of the particular cellular communication device and the network communication port corresponding to the particular cellular communication device; and
the network communication ports being accessible for use by software developers and testers.

10. The system of claim 9, wherein the server computer is located apart from the interface devices and communicates with the interface devices over a wide-area network.

11. The system of claim 9, wherein the interface devices comprise single-board computers having removable memory cards, each interface device being configured by storing a code image on the memory card of the interface device.

12. The system of claim 9, wherein each interface device is connected to no more than two of the cellular communication devices.

13. The system of claim 9, wherein the cellular communication devices comprise one or more of:
devices that are currently available for purchase by consumers;
devices that are in development for future release to consumers; and
devices that were previously available for purchase by consumers but that are no longer available for purchase by consumers.

14. The system of claim 9, wherein:
the server computer is configured to provide a user interface (UI) that identifies one or more characteristics of the cellular communication devices;
the server computer being further configured to provide a port specification corresponding to one of the cellular communication devices that has been selected for access.

15. The system of claim 9, wherein the server computer is configured assign a first mobile device to a first entity and to prevent access to the first mobile device by a second entity while the particular cellular communication device is assigned to the first entity.

16. A method, comprising:
provisioning multiple test devices for communicating as part of a cellular communications network, each test device having a logical control interface;
configuring multiple interface devices for communicating with the logical control interfaces of the test devices;
configuring a server computer to communicate with the interface devices;
creating network communication ports at the server computer, the network communication ports being accessible through a wide-area network;
creating a communication channel corresponding to each test device, the communication channel for a particular test device extending between one of the network communication ports and the logical control interface of the particular test device, the communication channel being implemented at least in part by one of the interface devices; and
wherein the communication channels are accessible by software development devices through the network communication ports to communicate with the logical control interfaces of the test devices.

17. The method of claim 16, wherein the logical control interface of the particular test device is accessible through a USB (universal serial bus) port.

18. The method of claim 16, wherein configuring the multiple interface devices comprises configuring the multiple interface devices to communicate with the logical control interfaces of the test devices over a wired USB (universal serial bus) connection.

19. The method of claim 16, wherein creating the network communication ports comprises creating TCP (transmission control protocol) ports that are defined by an IP (Internet protocol) address of the server computer and by a TCP port number.

20. The method of claim 16, wherein the communication channel for the particular test device comprises:
a first network communication channel between said one of the network communication ports and said one of the interface devices; and
a second network communication channel between said one of the interface devices and the logical control interface of the particular test device.
